(19) United States
(12) Patent Application Publication
(10) Pub. No.: US 2009/0193851 A1
(43) Pub. Date: Aug. 6, 2009

(54) CORE SUCTION TECHNIQUE FOR THE FABRICATION OF OPTICAL FIBER PREFORMS

(76) Inventors: Nitin Kumar Goel, Uttar Pradesh (IN); Rogers H. Stolen, Gallatin, TN (US); Steven H. Morgan, Brentwood, TN (US); Daniel Kominsky, Christiansburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/382,811

(22) Filed: May 11, 2006

Related U.S. Application Data
(60) Provisional application No. 60/680,045, filed on May 12, 2005.

(51) Int. Cl. C03B 37/027; C03B 37/03

(52) U.S. Cl. 65/404; 65/533

(57) ABSTRACT

Optical fiber preforms which can be drawn into optical fibers of desired dimensions are fabricated by applying a vacuum to a cladding tube and drawing molten glass from a crucible into a bore of the cladding tube while a portion of the cladding tube is within a furnace preferably through a small hole in the top of the furnace. The method and apparatus are particularly applicable to highly non-linear fiber (HNLF) glasses and highly doped or rare earth glasses since materials therein are generally expensive and only a small quantity of molten glass is required but can be applied to virtually any optical fiber construction where the core glass has a lower melting or softening point than that of the cladding tube. Sources of contamination, breakage and other preform defects are substantially avoided and toxic substances, if present are readily confined.

### CROSS-REFERENCE TO RELATED APPLICATIONS

This application claims benefit of priority of U.S. Provisional Patent Application Ser. No. 60/680,045, filed May 12, 2005, which is hereby incorporated by reference in its entirety.

### STATEMENT OF GOVERNMENT INTEREST

The development of this invention was funded by the National Science Foundation, grant number ECS-0123484 and the National Institute of Aerospace, grant number VT-03-1. Accordingly, the United States Government has certain interests in this invention.

### BACKGROUND OF THE INVENTION

1. Field of the Invention

The present invention generally relates to optical fibers and, more particularly, to preforms for the fabrication of optical fibers including highly non-linear non-conventional glasses as a core material thereof.

2. Description of the Prior Art

Fiber optics are becoming of very widespread use for communication links due to their degree of noise immunity and potential bandwidth. Numerous designs of low loss optical fibers are known and commercially available in long lengths and their performance is well-documented and subject to industry standards. Fiber optics also have many applications such as in light amplifiers where nonlinear effects are of primary importance and require non-standard fibers with very high non-linearity in short lengths. Such fibers with very high non-linearity glasses in the core are known as highly non-linear fibers (HNLFs). Additionally, optical fibers are often made in short lengths of highly doped glasses which are also drawn from preforms. An example of such glasses is MM2 glass from Kigre, Inc. which is highly doped with erbium but not a non-linear glass.

Attempts to fabricate HNLFs fall into three general categories which can be classified and are generally referred to as Modified Chemical Vapor Deposition MCVD techniques, crucible methods and rod-in-tube, respectively. MCVD techniques which involve a layer-by-layer deposition of material of a core (which can form a highly non-linear optical region) inside a cladding tube, offer the greatest potential for high purity and tight confinement but the processes are very slow and somewhat complicated, particularly for multi-component glasses in the core. (Cladding is a layer of material surrounding the core generally to increase efficiency of light transmission and reduce light loss. Such a layer surrounding the core may or may not function as cladding but the term “cladding” will be used herein as a collective reference to materials surrounding an optical fiber core, regardless of its actual function.) Crucible and rod-in-tube approaches usually involve processing of bulk glass samples or glass powders and using the cladding tube essentially as a crucible for the core glass where softening or melting of the core glass occurs principally during drawing of the optical fiber from the preform. Core glasses can be processed separately and then combined with cladding material using all of the above-mentioned techniques. Also, since HNLFs and highly doped glasses are non-standard, it may be desirable to include any of a wide variety of materials in the core glass, some of which may be highly toxic. None of the above known techniques of fabricating optical fiber preforms lend themselves particularly well to confinement of substances and vapors which may be toxic without the addition of particular structures for that purpose or other significant complication of the respective processes.

The most significant difficulty with these techniques derives from the desired small core diameter of the final fiber drawn from the preform. Non-linear glasses are usually associated with very high refractive indices as compared to silica. High refractive indices lead to a need for a very small core diameter between 0.5 and 1.0 microns to maintain the fiber single mode. A small core diameter increases the non-linearity by reducing effective area. Thus, most such HNLFs are fabricated by drawing fibers to the final desired size from preforms which can be substantially larger in cross-sectional dimensions. Even so, a 0.5 micron core in a 125 micron fiber requires that the inner diameter of a 1 cm cladding tube be only 40 microns. Thus, the core glass fiber would have to be drawn to a diameter of less than 40 microns prior to being inserted into a cladding tube (of a type which allows splicing to other fibers) before the assembly is drawn to final desired dimensions thus complicating and introducing additional failure modes into the assembly and drawing processes to produce the preform and then the optical fiber.

Further, additional problems have been encountered in known assembly and fabrication techniques for HNLFs. For example, trapped air entrained due to the necessary initial clearance between cladding and core may form bubbles within the cladding and it is anticipated that such bubbles will become more of a problem as the core and cladding bore become smaller. There is also a limit to the size from which a fiber having the desired final dimensions can be drawn due to the large thermal expansion coefficient (CTE) of high non-linearity glasses. These assembly and drawing techniques can also be sources and opportunities for contamination of the fiber at several stages of these processes.

### SUMMARY OF THE INVENTION

It is therefore an object of the present invention to provide a technique of forming a preform for a highly non-linear optical fiber (HNLF) in which core material may be made to completely fill an inner bore of cladding material or the like and which can be spliced to other optical fibers.

It is another object of the present invention to provide an alternative, rapid, repeatable, robust and economical technique of producing optical fiber preforms to known techniques of fabricating optical fiber preforms, particularly for HNLFs.

It is a further object of the invention to provide an arrangement for fabrication of fiber optic preforms which allows safe fabrication even if toxic substances are to be included in the glass core.

It is yet another object of the invention to provide a technique of forming preforms, particularly preforms with very small diameter cores, and which will decrease the incidence of breakage and defects.

In order to accomplish these and other objects of the invention, a method is provided for fabricating optical fiber preform or an optical fiber comprising steps of melting or softening a glass material in a crucible enclosed in a furnace, introducing one end of a cladding tube into said furnace through an aperture in said furnace and below a surface of said glass material, and applying suction to an opposite end of said cladding tube to draw said glass material into said cladding tube.

In accordance with another aspect of the invention, an apparatus is provided comprising, in combination, a furnace including a heat source and a crucible containing molten glass, an arrangement such as an aperture for introducing a portion of a cladding tube into said furnace such that a first end of said cladding tube reaches a surface of said molten glass in said crucible, and a vacuum pump arrangement for applying vacuum to a second end of said cladding tube to draw said molten glass into said cladding tube by suction.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic depiction of apparatus suitable for practice of the invention and useful for explanation of the principles and methodology of the invention,

FIG. 2 is a photomicrograph of a cross-section of an optical fiber drawn from a preform fabricated using the apparatus and technique depicted in FIG. 1, and

FIG. 3 depicts the output mode pattern of the optical fiber of FIG. 2 having a red He—Ne light input.

### DETAILED DESCRIPTION OF A PREFERRED EMBODIMENT OF THE INVENTION

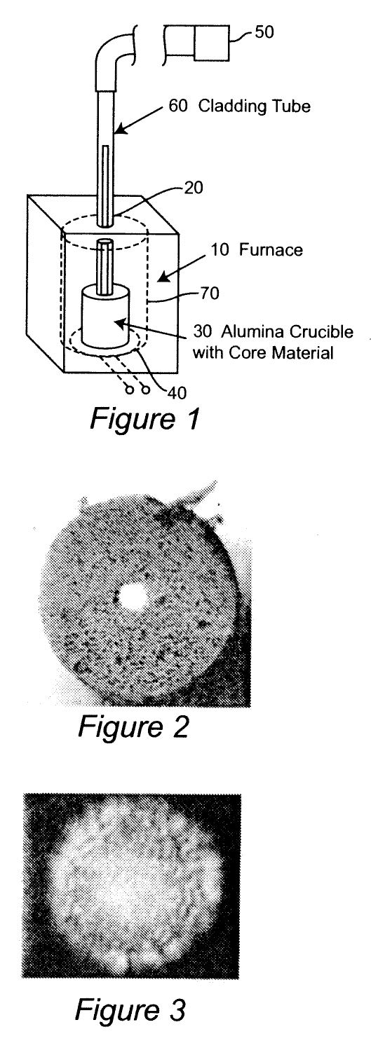

Referring now to the drawings, and more particularly to FIG. 1, there is shown a schematic depiction of basic apparatus for practice of the invention by which the principles and methodology of the invention sufficient to its successful practice may be readily conveyed to those skilled in the art. The basic apparatus sufficient to practice the invention is extremely simple and suitable structures from which the apparatus may be assembled are commercially available. Basically, the apparatus comprises a muffle furnace 10 or other type of furnace preferably dimensioned to accommodate a principal portion, if not all, of a preform of the desired length which is generally equipped with a thermometer hole 20. (In general, the preform that can be fabricated will be substantially limited to the portion of the cladding tube which can be heated in the furnace since the core glass will generally solidify quickly upon reaching an unheated portion of the cladding tube. Common sizes of thermometer holes provided in commercially available muffle furnaces are normally adequate to accommodate cladding tubes of sizes generally used. If a thermometer hole is not provided or is of a size other than to closely fit around the outer diameter of a cladding tube, a suitable modification can be easily provided in order to do so. A crucible 30 of alumina or other refractory material capable of withstanding a temperature somewhat in excess of the melting point of the intended core glass or simply a conventional crucible suitable for glass processing is provided within the furnace 10, along with a heat source 40, the particulars of which are not important to the successful practice of the invention. A vacuum pump 50 of any known type but preferably capable of drawing a vacuum at least sufficient for drawing molten glass into a cladding tube having small bore dimensions comparable to those noted above or smaller to fabricate an optical fiber preform within a sufficiently short time to suitably limit any significant diffusion or non-uniformity over the length of the preform in accordance with the invention which can then be drawn to the desired final dimensions in a manner well-understood in the art. (The required vacuum will vary with viscosity of the glass which will, in turn, vary with temperature and thus the required vacuum levels may be limited to practical levels by suitable choice of glass temperature.)

It should be appreciated that the technique of drawing core glass into the bore of a cladding tube using suction is possible due to the fact that the melting or softening temperatures of highly non-linear core glasses and highly doped glasses are much less than that of the cladding tube which is generally of silica but lower melting or softening temperature glasses such as boro-silicate glass can also be used for lower softening or melting temperature core glasses. By the same token, the invention is completely applicable to fabrication of preforms for optical fibers of conventional composition as long as a suitable differential of melting/softening temperatures between the core glass material and the cladding material can be provided. Therefore, the bore of the cladding tube can effectively be used in the manner of a mold for the core glass which is drawn into it, thus eliminating voids and ambient gas entrainment and core rod breakage which have been observed when a solid core rod is inserted into the cladding tube. Furnace 10, when in use, has only one opening for the insertion of the cladding tube (and vacuum connection and thus is able to confine and toxic gasses which may be present or evolved from the molten glass. Such gasses which are drawn into vacuum pump 50 may be suitably confined or exhausted. Further, since the core glass is drawn into the cladding tube in a molten state, it is believed that incidence of breakage due to differences of the coefficient of thermal expansion between the cladding and core during drawing of the preform into an optical fiber at an elevated temperature is reduced.

To fabricate a preform using apparatus of the general type and having the features illustrated in FIG. 1, the materials required for core glass of the desired composition is charged into the crucible 30 and melted by application of heat from heat source 40. It is a meritorious effect of the present invention that only a very small amount of core glass material need be provided and melted since novel and non-standard glasses to which the invention is particularly applicable may contain materials which are very expensive. When the glass in crucible 30 has reached the desired temperature to provide a suitable viscosity (but below the melting point of the cladding tube) in view of the bore of the cladding tube and vacuum level so that the bore can be filled in a suitably short time, the end of the cladding tube 60 is inserted into the muffle furnace 10 through the thermometer hole 20 and into the glass in the crucible 30 and vacuum is applied to the other end of the cladding tube 60 by vacuum pump 50 to draw the molten core glass into the cladding tube.

It will be recognized by those skilled in the art that the above process involves numerous interrelated parameters and many possibilities for process variation; each of which may be chosen within a relatively wide range consistent with successful practice of the invention. For example, the vacuum can be applied either before or after the insertion into the muffle furnace and crucible. The choice may involve such factors as the desired temperature of the cladding tube and its specific heat which should be such that the molten core glass does not significantly solidify due to temperature drop through heat transfer to the cladding tube during the suction process and drawing the high temperature ambient atmosphere within the furnace through the cladding tube prior to suctioning of the glass may allow the cladding tube to reach the desired temperature more quickly.

In general, in this regard, it is preferable that the dimensions of the muffle furnace 10 be such that substantially all of the cladding tube can be received therein with no more extension, if any, outside the muffle furnace than is necessary for connection to the vacuum pump 50. For longer preforms, a so-called horizontal tube furnace can be oriented vertically to accommodate the cladding tube vertically therein and used in place of a muffle furnace. Elongated furnaces such as those conventionally used for fiber drawing operations can also be used as well as furnaces of custom dimensions to accommodate preforms of whatever dimensions may be desired and can include such features as silica liners and structures 70 such as for passing inert gases or other controlled atmospheres over the cladding to further reduce the potential for contamination can be provided as schematically and collectively illustrated in FIG. 1. (Incidentally, in practice, some difficulty was initially encountered during insertion of the cladding tube into the furnace causing displacement or overturning of the crucible. If a structure such as is schematically depicted at 70 of FIG. 1 is dimensioned to fit closely around the crucible, it can also serve to guide the cladding tube to the crucible as well as supporting the crucible; thus eliminating this early problem.) Since these other types of furnace differ from a muffle furnace principally by dimensions, the illustration of furnace 10 should be considered as a collective illustration of any and all types of furnaces capable of accommodating regardless of nomenclature. Thus, the furnace of whatever type is used can provide pre-heating of all or most of the cladding tube to a temperature which will prevent the core glass from solidifying during the suction of the core glass. In this regard, it may be preferable to insert the cladding tube end into the furnace to a point which does not initially reach the molten core glass such that drawing ambient furnace gases through the cladding tube expedites the preheating process, as alluded to above. On the other hand, in some cases it may be desirable to limit or avoid preheating depending on the materials in the core glass and the diffusivity thereof into the cladding material (or vice-versa) at a given temperature or the desired material concentration profile at the interface of the core and cladding. Diffusion of material from the core into the cladding may also be limited to a degree by the speed of the suction process as well as by the provision of one or more barrier layers within the cladding tube prior to the core suction process.

Similarly, the level of vacuum applied is generally not critical to the practice of the invention but should be great enough to complete the suction process in a reasonable time (and with good uniformity if diffusion from the core to the cladding may be significant) based on the viscosity of the molten core glass but low enough to avoid any out-gassing from the molten glass other than above the molten glass column or breakage of portions which are allowed to solidify during the suction process (e.g. using reduced cladding tube preheating). The temperature of the molten core glass will affect viscosity of the core glass which should be low enough that molten core glass can continuously flow to the cladding tube bore during the suction process without cavitation or aspiration of furnace gasses into the cladding tube bore as well as flowing within the usually very narrow bore of the cladding tube with an acceptable and practical level of vacuum.

These and other concerns regarding the interrelationships of variable process parameters will be apparent to those skilled in the art in order to predict combinations of process parameters which might produce flaws in the preforms. However, it is to be understood that the process is extremely robust, empirical in nature and may be successfully practiced over a wide range of values of process parameters and variations. Even the first experimental trial of the method described above using a mixture of pure GeO₂ and TeO₂ powders was successful in fabricating an HNLF optical fiber preform. Therefore, the discussion of variation in the parameters of the process in accordance with the invention will principally assist in avoiding combinations of parameter values which can be projected to be unsuccessful.

The method has also been successfully and repeatedly performed with good yield using conventional materials such as Schott SFL6 glass to form preforms with core diameters ranging from 22 to 45 microns from which optical fibers with suitably small core diameters, as noted above, have been successfully drawn with good yield. Other core glass materials successfully used in accordance with the invention to date also include Lead-Germanate-Telluite based materials of various compositions and many other glass formulations with which the invention has provided uniformly successful results. It should also be appreciated that layers of other materials such as a barrier layer may be applied within the cladding tube (e.g. by MCVD) for any desired purpose or function.

FIG. 2 shows a cross-section of an optical fiber drawn from the preform fabricated in accordance with the invention as described above. FIG. 2 shows the tight confinement of light inside the core, indicating a very high quality of optical fiber. FIG. 3 shows the multimode output pattern resulting from the launch of He—Ne light at a 632.8 nm wavelength through the optical fiber of FIG. 2.

In view of the foregoing, it is clearly seen that the invention provides an alternative technique for forming small diameter preforms from which very small diameter optical fibers of relatively short length can be drawn, even when using core materials suitable for HNLF fibers. The method in accordance with the invention is a rapid, repeatable, robust and economical technique of producing optical fiber preforms and uses a furnace which is preferably closed and/or amenable to providing a controlled atmosphere therein and thus can also confine materials which may be toxic and controlling sources of potential contamination which, in any event, are much reduced in number and likelihood of causing contamination than the greater number of steps of known processes for making preforms. Potential sources of other defects such as entrained air are also substantially avoided in accordance with the invention and toxic materials, if present may be readily confined.

The technique in accordance with the invention is principally suitable for but not limited to, highly doped non-conventional multi-component glasses. These novel glasses, mainly used for optical amplification (such as Raman amplifiers and EDFA amplifiers), lasers, lidar, etc. applications, could either be tellurium, bismuth, germanium of the like based highly non-linear glasses or highly doped rare earth glasses like erbium or neodymium or the like or any other material of combination thereof.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of fabricating an optical fiber preform, said method comprising steps of
melting or softening a glass material in a crucible enclosed in a furnace,
introducing one end of a cladding tube into said furnace through an aperture in said furnace and below a surface of said glass material, and
applying suction to an opposite end of said cladding tube to draw said glass material into said cladding tube.

2. A method as recited in claim 1, further including a step of
preheating said cladding tube.

3. A method as recited in claim 1, further including a step of
depositing at least one layer of material within a bore of said cladding tube.

4. A method as recited in claim 3, wherein said at least one layer of material is a barrier layer.

5. A method as recited in claim 1, wherein said glass material is a highly non-linear fiber (HNLF) glass

6. A method as recited in claim 1, wherein said glass material is a highly doped glass.

7. A method as recited in claim 1 wherein said glass material is a rare earth glass.

8. A method as recited in claim 1, wherein said cladding tube is formed of silica.

9. A method of fabricating an optical fiber, said method comprising steps of
melting or softening a glass material in a crucible enclosed in a furnace,
introducing one end of a cladding tube into said furnace through an aperture in said furnace and below a surface of said glass material,
applying suction to an opposite end of said cladding tube to draw said glass material into said cladding tube to form a preform, and
drawing said preform into an optical fiber of desired dimensions.

10. A method as recited in claim 9, further including a step of
preheating said cladding tube.

11. A method as recited in claim 9, further including a step of
depositing at least one layer of material within a bore of said cladding tube.

12. A method as recited in claim 11, wherein said at least one layer of material is a barrier layer.

13. A method as recited in claim 9, wherein said glass material is a highly non-linear fiber (HNLF) glass

14. A method as recited in claim 9, wherein said glass material is a highly doped glass.

15. A method as recited in claim 9 wherein said glass material is a rare earth glass.

16. A method as recited in claim 9, wherein said cladding tube is formed of silica.

17. An apparatus comprising, in combination,
a furnace including a heat source and a crucible containing molten glass,
means for introducing a portion of a cladding tube into said furnace such that a first end of said cladding tube reaches a surface of said molten glass in said crucible, and
vacuum pump means for applying vacuum to a second end of said cladding tube to draw said molten glass into said cladding tube by suction.

18. An apparatus as recited in claim 17, wherein said furnace is a muffle furnace.

19. An apparatus as recited in claim 17, wherein said furnace further includes
means for directing a desired gas across a surface of said cladding tube.
